(19) United States
(12) Patent Application Publication
(10) Pub. No.: US 2003/0008058 A1
(43) Pub. Date: Jan. 9, 2003

(54) Additive, food, beverage, seasoning, and cosmetic product

(75) Inventors: Toyohiko Ariga, Tokyo (JP); Tadao Kawakami, San Francisco, CA (US)

Correspondence Address: ARMSTRONG,WESTERMAN & HATTORI, LLP, 1725 K STREET, NW., SUITE 1000, WASHINGTON, DC, 20006, US

(73) Assignee: Kawakami Trading Inc., San Francisco, CA

(21) Appl. No.: 10/161,598

(22) Filed: Jun. 5, 2002

(30) Foreign Application Priority Data
Jun. 19, 2001 (JP) 2001-184549
May 16, 2002 (JP) 2002-141820

(51) Int. Cl. C12C 1/00

(52) U.S. Cl. 426/590

(57) ABSTRACT

The additive according to the present invention contains the fruit juice of a prickly pear cactus. The prickly pear cactus fruit juice contains rich vitamins, minerals, soluble dietary fiber, pectin, etc. Thus, the additive prevents increase of body weight even when the amount of food being taken is increased. The rich soluble fiber included in the prickly pear cactus fruit juice shortens the intestinal retention time of food, thereby regulating the functions of the intestines, preventing obese. The additive reduces the adipose tissue weight without increasing organ weight. The additive also reduces serum lipids by the pectin included in the cactus fruit juice.

### FIELD OF THE INVENTION

The present invention relates to an additive, food product such as heath food, dairy product, sweets, bread, ice cream, sherbet and jam, beverage such as soft drink, fruit juice, vegetable juice, lactic acid bacteria beverage and alcoholic beverage, seasoning, and cosmetic product that contain the fruit juice of a prickly pear cactus.

### DESCRIPTION OF THE RELATED ART

The prickly pear cactus, which is a plant of the family Cactaceae, can be found in a wide area ranging from the southwest of America to a portion of Canada, and grows on its stem a bright purple red fruit.

The fruit of the prickly pear cactus has been one of the favorite foods among cowboys from the time of settlement of the American West.

Presently, the fruit juice of the prickly pear cactus is simply enjoyed as juice, or the puree of the prickly pear cactus fruit is used as sauce for meat, fish, and boiled vegetables.

Further, it is common to process the prickly pear cactus fruit to make jam and syrup, which can be garnished on pancakes and ice cream.

Moreover, the puree of the prickly pear cactus fruit has long been used to make cactus jelly.

The fruit of the prickly pear cactus is rich in vitamins and minerals; the vitamin C content of one prickly pear cactus fruit is substantially equal to that of a tomato, and the vitamin A content thereof is significantly greater than that of a tomato.

The fruit of the prickly pear cactus also contains a large amount of soluble dietary fiber and calcium, and also includes much pectin. The pectin functions to reduce the low-density lipoprotein-cholesterol (LPL) in the blood, and the effect thereof is higher than other fruits and vegetables, etc. even if only a little amount is consumed.

The fruit of the prickly pear cactus has been a popular diet food among Native Americans from old times, and even now, the fruit attracts the attention of obese Native Americans suffering from over-cholesterol as a highly effective diet health food.

Japanese Patent Laid-Open Provisional Publication No. H8-332028 discloses a conventional frozen dessert containing a cactus component.

Moreover, Japanese Patent Laid-Open Provisional Publication No. H11-123073 discloses a food or drink including 0.01 to 50 wt % of frothing agent made of a component of a plant of the family Cactaceae.

However, Japanese Patent Laid-Open Provisional Publication No. H8-332028 contains as cactus component a fermentation extraction liquid of cactus prepared by decomposing and fermenting the finely grated stem of the cactus.

Further, the food or drink disclosed in Japanese Patent Laid-Open Provisional Publication No. 11-123073 contains as cactus plant component the squeezed juice of the plant of the family Cactaceae.

### SUMMARY OF THE INVENTION

The first object of the present invention is to provide an additive containing a fruit juice of a prickly pear cactus. According to tests studying on the influence that the administration of the fruit juice of prickly pear cactus has on the body weight, the organ weight and the adipose tissue weight, the present additive containing the fruit juice of the prickly pear cactus is rich in vitamins, minerals, soluble dietary fiber, pectin etc., so even if the amount of consumed food is increased, the present additive is capable of preventing increase of the body weight, shortening the intestinal retention time of the food, effectively regulating the functions of the intestines and preventing obese by the rich soluble fiber contained in the fruit juice of the prickly pear cactus, preventing increase of organ weight, reducing the adipose tissue weight, and reducing serum lipids by the rich pectin contained in the fruit juice of the prickly pear cactus.

The second object of the present invention is to provide a food product having added thereto an additive including the fruit juice of a prickly pear cactus, the food being capable of suppressing the increase of body weight, shortening the intestinal retention time of the food by the fiber such as soluble fiber and pectin richly contained in the fruit juice of the prickly pear cactus, preventing colon cancer, effectively regulating the functions of the intestines and preventing obese by the fiber richly contained in the fruit juice of the prickly pear cactus, and suppressing the low-density lipoprotein-cholesterol in the blood by the rich pectin contained in the fruit juice of the prickly pear cactus.

The third object of the present invention is to provide a beverage having added thereto an additive including the fruit juice of a prickly pear cactus, the beverage being capable of suppressing the incase of body weight, shortening the intestinal retention time of the food by the fiber such as soluble fiber and pectin richly contained in the fruit juice of the prickly pear cactus, preventing colon cancer, effectively regulating the functions of the intestines and preventing obese by the fiber richly contained in the fruit juice of the prickly pear cactus, and suppressing the low-density lipoprotein-cholesterol by the rich pectin contained in the fruit juice of the prickly pear cactus.

The fourth object of the present invention is to provide a seasoning having added thereto an additive containing the fruit juice of a prickly pear cactus, the seasoning being capable of suppressing the increase of body weight, shortening the intestinal retention time of the food by the fiber such as soluble fiber and pectin richly contained in the fruit juice of the prickly pear cactus, effectively regulating the functions of the intestines and preventing obese by the rich dietary fiber contained in the fruit juice of the prickly pear cactus, and suppressing the low-density lipoprotein-cholesterol by the rich pectin contained in the fruit juice of the prickly pear cactus.

The fifth object of the present invention is to provide a cosmetic product having added thereto an additive containing the fruit juice of a prickly pear cactus, the cosmetic product being good for the skin with the rich vitamins and minerals contained in the fruit juice of the prickly pear cactus, having no negative effects on the skin.

The additive of the present invention characterizes in containing a fruit juice of a prickly pear cactus.

The food product of the present invention characterizes in including an additive containing a fruit juice of a prickly pear cactus.

The beverage of the present invention characterizes in including an additive containing a fruit juice of a prickly pear cactus.

The seasoning of the present invention characterizes in including an additive containing a fruit juice of a prickly pear cactus.

The cosmetic product of the present invention characterizes in including an additive containing a fruit juice of a prickly pear cactus.

### BRIEF DESCRIPTION OF THE DRAWINGS

FIG. 1 is a flowchart showing the procedure for making a puree which is the fruit juice of the prickly pear cactus according to the embodiment of the present invention.

### DETAILED DESCRIPTION OF THE PREFERRED EMBODIMENT

The preferred embodiment of the present invention will now be explained with reference to the drawings.

The additive according to the present invention contains a fruit juice of a prickly pear cactus, which is a plant of the family Cactaceae.

The food product according to the present invention includes an additive containing a fruit juice of a prickly pear cactus.

The beverage according to the present invention includes an additive containing a fruit juice of a prickly pear cactus.

The seasoning according to the present invention includes an additive containing a fruit juice of a prickly pear cactus.

The cosmetic product according to the present invention includes an additive containing a fruit juice of a prickly pear cactus.

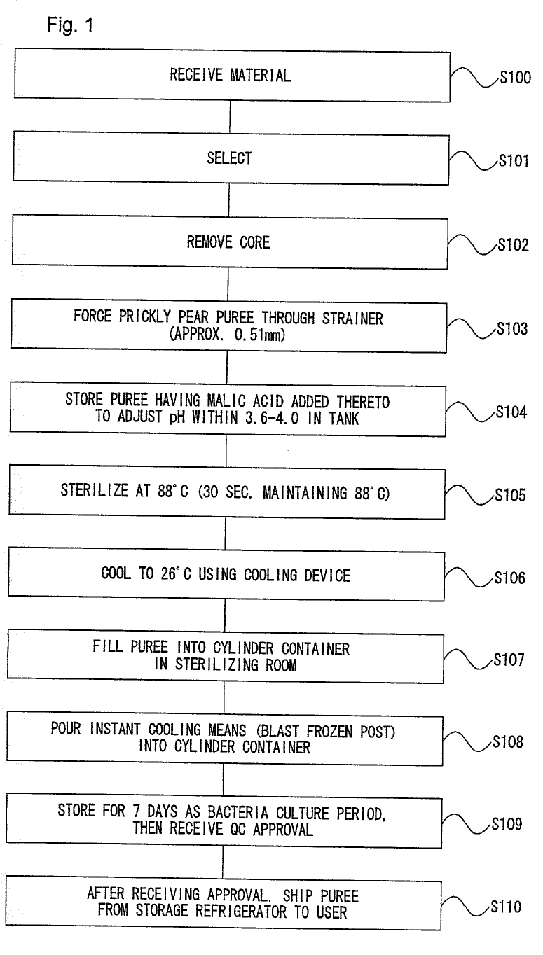

FIG. 1 is a flowchart showing the procedure of manufacturing a puree which is the fruit juice of a prickly pear cactus according to the preferred embodiment of the present invention.

At first, the material goes through receiving inspection where the color, the ripeness, etc. of the prickly pear cactus having the prickles removed in advance is checked before the fruits of the prickly pear cactus are actually received (step S100).

Next, the received prickly pear cactus fruits are selected (step S101).

Thereafter, the selected prickly pear cactus fruits are washed, and the core of each prickly pear cactus fruit is removed (step S102).

Next, the prickly pear cactus fruits having their cores removed are mashed into puree, and the puree of the prickly pear cactus fruit is filtered through a strainer with a mesh of approximately 0.51 mm (step S103).

In the subsequent step, a malic acid is added to the filtered puree of the prickly pear cactus fruit in order to adjust the pH of the puree to fall under the standard range of 3.6-4.0, and the cactus fruit puree containing the malic acid is stored in a tank (step S104).

Thereafter, the cactus fruit puree stored in the tank is heated for 30 seconds maintaining 88° C. for sterilization (step S105).

Next, the sterilized cactus fruit puree is cooled to 26° C. using a cooling device (step S106).

Then, the cooled fruit puree is poured from the tank into a cylindrical container inside a sterilizing room (step S107).

In the subsequent step, an instantaneous cooling means (blast frozen post) is put into the cylindrical container filled with cactus fruit puree, thereby instantaneously cooling the puree filled in the cylindrical container (step S108).

Thereafter, the cylinder container filled with cactus fruit puree is stored in a storage refrigerator for seven days as bacteria culture period, before sampling is taken to check the quality of the puree stored in the cylinder container. Thereby, the prickly pear cactus fruit puree is ready to receive quality control (QC) approval (step S109).

After receiving quality control approval, the cylindrical container filled with prickly pear cactus puree is taken out of the storage refrigerator and loaded on a ship to be shipped to the user (step S110).

We will now explain the influence that the administration of prickly pear cactus fruit juice has on the body weight, the organ weight, and the adipose tissue weight of a rat.

A group of rats is fed with a feed including an additive containing the fruit juice of a prickly pear cactus, the weight of the fruit juice of the prickly pear cactus in the feed being 5 g/100 g by dry weight, and the content of the dietary fiber from the fruit juice of the prickly pear cactus in the feed being 1.2 g/100 g. According to this experiment, we have studied the influence that the administration of the prickly pear cactus fruit juice has on the body weight, the organ weight and the adipose tissue weight of the rats.

In order to study the influence that the administration of the cactus fruit juice has on the body weight, the organ weight and the adipose tissue weight of the rats, two kinds of feeds are prepared as test feed. One kind is a high-fat food containing 30% animal fat, and the other kind is a cactus food created by adding an additive containing the fruit juice of a prickly pear cactus to the high-fat food.

The cactus food is made using a hydrous product of the prickly pear cactus fruit juice, and adjusted so that the cactus fruit juice content becomes 5% in weight excluding moisture.

The rats that belong to the high-fat food group are fed with high-fat food and the rats belonging to the cactus food group are fed with cactus food made by adding the additive containing the prickly pear cactus fruit juice to the high-fat food, and after feeding 10 cases of high-fat food group rats and 10 cases of cactus food group rats for 34 days (in some cases, 35 days), the influence that the foods had on the rats belonging to the high-fat food group and the rats belonging to the cactus food group are compared.

According to the experiment, the amount of food consumed by the rats of the high-fat food group was 850.4±12.1 g, whereas the amount of food consumed by the rats of the cactus food group was 921.9±11.1 g. The amount of food consumed by the cactus food group rats was increased by approximately 8% compared to that of the high-fat food group rats. In other words, there was a noticeable increase in the amount of food consumed by the rats fed with cactus food.

The increase in the amount of food consumed by the cactus food group rats is considered to be caused by the following reasons. One reason for the increase in the amount of food consumed by the cactus food group rats is considered to be that the fruit juice of the prickly pear cactus being added to the food improved the taste thereof. The other reason is considered to be that the cactus food group rats had to take in more food in order to compensate for the reduced amount of energy per unit weight of the food having the cactus fruit juice added thereto, and to compensate for the decrease in the energy ingestion caused by the reduced lipid absorption effect of the cactus fruit juice.

The body weight of the rat belonging to the high-fat food group were 406.8±9.1 g, whereas the body weight of the rats belonging to the cactus food group were 403.2±8.4 g. Compared to the body weight of the high-fat food group rats, the weight of the cactus group rats were reduced by approximately 1%, and the weight thereof were substantially unchanged.

Even though the amount of food taken by the cactus food group rats was incased, the weight thereof was somewhat lower than that of the high-fat food group rats. The reason for this is considered to be the effect of the amount of dietary fiber (1.2%) contained in the food fed to the cactus food group rats.

The intestinal retention time of the food fed to the high-fat food group rats was 14.5±0.5 h, and the intestinal retention time of the food fed to the cactus food group rats was 12.5±0.2 h, the intestinal retention time of the food of the cactus food group rats being reduced by approximately 14% compared to that of the high-fat food group rats. There was a significant reduction in the intestinal retention time of the food fed to the cactus food group rats. As for the organ weight of the rats, the liver weight of the high-fat food group rats was 10.1±0.5 g, whereas the liver weight of the cactus food group rats was 9.9±0.4 g. The liver weight of the cactus food group rats was almost the same as that of the high-fat food group rats, and the liver weight of the cactus food group rats was substantially unchanged. Moreover, the kidney weight of the high-fat food group rats was 2.7±0.1 g, whereas the kidney weight of the cactus food group rats was 2.7±0.1 g. The kidney weight of the cactus food group rats was the same as that of the high-fat food group rats, and the kidney weight of the cactus food group rats was substantially unchanged.

Further, the appendix weight of the high-fat food group rats was 7.1±0.2 g, whereas the appendix weight of the cactus food group rats was 7.5±0.3 g. The appendix weight of the cactus food group rats was increased by 5.6% compared to that of the high-fat food group rats, and the appendix weight of the cactus food group rats was increased.

The liver weight and the kidney weight of the cactus food group rats were almost the same as those of the high-fat food group rats, but the appendix weight of the cactus food group rats was increased by 5.6% compared to that of the high-fat food group rats. The reason for this is considered to be that the dietary fiber contained in the food reaching the colon of the cactus food group rats increased the functions of the appendix, such as the fermentation within the appendix.

As for the adipose tissue weight of the rats, the perinephria weight of the high-fat food group rats was 12.1±0.5 g, whereas the perinephria weight of the cactus food group rats was 10.7±0.5 g. The perinephria tissue weight of the cactus food group rats was reduced by 12% compared to that of the high-fat food group rats, and the perinephria tissue weight of the cactus food group rats was decreased.

The epididymal adipose tissue weight of the high-fat food group rats was 6.6±0.2 g, whereas the epididymal adipose tissue weight of the cactus food group rats was 6.2±0.3 g. The epididymal adipose tissue weight of the cactus food group rats was reduced by 1% compared to that of the high-fat food group rats, and the epididymal adipose tissue weight of the cactus food group rats was slightly reduced.

Based on the reduction of perinephria weight and the epididymal adipose tissue weight of the cactus food group rats, it could be said that a decrease in the adipose tissue weight of the cactus food group rats was recognized.

In conclusion, the adipose tissue weight of the cactus food group rats was clearly reduced compared to the high-fat food group rats. Even though the epididymal adipose tissue weight of the cactus food group rats was only slightly reduced by 1% compared to that of the high-fat food group rats, the perinephria tissue weight of the cactus food group rats was significantly reduced by 12% compared to that of the high-fat food group rats.

As for the serum lipids of the rats, the serum triglyceride (neutral fat) of the high-fat food group rats was 71.3±2.5 mg/dl, whereas the serum triglyceride (neutral fat) of the cactus food group rats was 55.6±6.6 mg/dl. The serum triglyceride of the cactus food group rats was reduced by 22% compared to that of the high-fat food group rats, and the serum triglyceride of the cactus food group rats was significantly cut down.

The serum cholesterol of the high-fat food group rats was 76.7±5.0 mg/dl, whereas the serum cholesterol of the cactus food group rats was 69.4±3.5 mg/dl. The serum cholesterol of the cactus food group rats was reduced by 10% compared to that of the high-fat food group rats, and the serum cholesterol of the cactus food group rats was significantly cut down.

In conclusion, the serum lipids of the cactus food group rats was clearly reduced compared to that of the high-fat food group rats, with the serum triglyceride of the former being reduced by 22% compared to that of the latter, and the serum cholesterol of the former being reduced by 10% compared to that of the latter.

Upon studying the influence that the administration of the prickly pear cactus fruit juice has on the body weight, the organ weight and the adipose tissue weight of the rats, all the aforementioned conditions, such as the suppress in lipid absorption, the compensation of energy lacked as a result of suppress in lipid absorption (excessive intake of food), and the increase in appendix weight, are recognized to reflect the increased amount of pectin and other dietary fiber contained in the food having added thereto the fruit juice of the prickly pear cactus.

In the following, examples are provided in which the fruit juice of the prickly pear cactus is processed into powder.

1. We will now explain the steps for processing the prickly pear cactus fruit juice into powder.

The material (cactus fruit juice) is blended with water and dextrin is mixed thereto, before the liquid is sterilized at 85° C. for 15 minutes. Then, the liquid is spray dried (exit temperature: 95° C.), and the dried material is sieved (50-mesh, 10000 gauss) to obtain an odorless white powder.

The mixing ratio (weight %) of the material (cactus fruit juice) and dextrin is within the range from 60:40 to 10:90.

The present powder has improved usability as material, and is suited for use as supplement food.

2. We will now provide preferred examples of various beverages, food and cosmetics containing the fruit juice of the prickly pear cactus as additive.

### EXAMPLE 1

### Cactus Jelly

| | |
|---|---|
| 10.0 wt % | prickly pear cactus fruit juice |
| 20.0 wt % | granulated sugar |
| 1.0 wt % | gelatinizer |
| 0.4 wt % | citric acid |
| 0.2 wt % | sodiun citrate |
| 1.5 wt % | passion fruit liquor (Passoa) |
| 0.5 wt % | rum |
| 66.4 wt % | water |

The prickly pear cactus fruit juice being flavored with a flavoring agent in advance is blended with other ingredients mentioned above, then the mixture is heated at 85° C. for 15 minutes to obtain cactus jelly.

### EXAMPLE 2

### Cactus Drink

| | |
|---|---|
| 13.0 wt % | prickly pear cactus fruit juice |
| 2.0 wt % | high-fructose corn syrup (Brix 75°) |
| 0.3 wt % | citric acid (crystal) |
| 0.1 wt % | sodium citrate |
| 0.03 wt % | vitamin C |
| 0.3 wt % | flavor |
| 84.27 wt % | purified water |

The prickly pear cactus fruit juice is blended with other ingredients mentioned above, and the mixture is heated at 80° C. for 10 minutes to obtain cactus drink.

### EXAMPLE 3

### Cactus Candy

| | |
|---|---|
| 5.0 wt % | prickly pear cactus fruit juice |
| 50.0 wt % | granulated sugar |
| 43.2 wt % | starch syrup |
| 1.0 wt % | citric acid |
| 0.5 wt % | passion fruit liquor (Passoa) |
| 0.3 wt % | rum |

The prickly pear cactus fruit juice having been flavored with a flavoring agent is blended with the other ingredients and heated at 70° C. for 20 minutes to obtain cactus candy.

### EXAMPLE 4

### Cactus Strawberry Jam

| | |
|---|---|
| 15.0 wt % | prickly pear cactus fruit juice |
| 50.0 wt % | strawberry |
| 25.0 wt % | sugar |
| 9.7 wt % | starch syrup |
| 0.3 wt % | citric acid |

The above ingredients are dissolved and mixed, with the Brix controlled to 500-600.

### EXAMPLE 5

### Cactus Apple Jam

Cactus apple jam can be made similarly as EXAMPLE 4.

### EXAMPLE 6

### Cactus Skin Lotion

| | |
|---|---|
| 5.0 wt % | prickly pear cactus fruit juice |
| 20.0 wt % | ethanol |
| 8.0 wt % | pyrrolidone carboxylic acid |
| 0.2 wt % | jojoba oil |
| 0.3 wt % | polyoxyethylene oleyl alcohol ethanol |
| 0.05 wt % | sodium citrate |
| 0.05 wt % | methylparaben |
| 0.01 wt % | sodium sulfocarbolate |
| 0.01 wt % | photosensitive element |
| 0.01 wt % | aroma chemical |
| 0.01 wt % | coloring material |
| 0.01 wt % | discoloration preventing agent |
| 66.35 wt % | ion-exchange water |

Prickly pear cactus fruit juice, ion-exchange water, pyrrolidone carboxylic acid, sodium sulfocarbolate, sodium citrate, photosensitive element, aroma chemical, coloring material, discoloration preventing agent (ethanol-soluble component), and jojoba oil are dissolved to polyoxyethylene oleyl alcohol ethanol, the mixture being solubilized under room temperature to obtain cactus skin lotion.

The prickly pear cactus juice can also be blended into emulsion, cream, lotion etc. so as to solve skin problems.

The effect of the present invention will now be explained.

According to tests examining the influence of the administration of prickly pear cactus fruit juice to the body weight, the organ weight and the adipose tissue weight, the additive of the present invention containing the prickly pear cactus fruit juice can suppress the increase of body weight even when the amount of consumed food is increased, reduce the intestinal retention time of food, regulate the functions of the intestines and prevent obese by the soluble dietary fiber richly contained in the prickly pear cactus fruit juice, reduce the adipose tissue weight while suppressing increase of organ weight, and cut down serum lipids by the pectin richly contained in the cactus fruit juice.

The food product according to the present invention including the additive containing the prickly pear cactus fruit juice can suppress the increase of body weight, prevent colon cancer since the rich dietary fiber such as soluble fiber and pectin included in the prickly pear cactus fruit juice shortens the intestinal retention time of food, regulate the functions of the intestines and prevent obese by the rich dietary fiber contained in the cactus fruit juice, and suppress low-density lipoprotein-cholesterol within the blood by the rich pectin contained in the juice. Thus, the present food is good for the health.

The beverage according to the present invention including the additive containing the prickly pear cactus fruit juice can suppress the increase of body weight, prevent colon cancer since the rich dietary fiber such as soluble fiber and pectin included in the prickly pear cactus fruit juice shortens the intestinal retention time of food, regulate the functions of the intestines and prevent obese by the rich dietary fiber contained in the cactus fruit juice, and suppress low-density lipoprotein-cholesterol within the blood by the rich pectin contained in the juice. Thus, the present beverage is good for the health.

The seasoning according to the present invention including the additive containing the prickly pear cactus fruit juice can suppress the increase of body weight, prevent colon cancer since the rich dietary fiber such as soluble fiber and pectin included in the prickly pear cactus fruit juice shortens the intestinal retention time of food, regulate the functions of the intestines and prevent obese by the rich dietary fiber contained in the cactus fruit juice, and suppress low-density lipoprotein-cholesterol within the blood by the rich pectin contained in the juice. Thus, the present seasoning is good for the health.

The cosmetic product according to the present invention including the additive containing the prickly pear cactus fruit juice can improve the health of the skin with the rich vitamins and minerals contained in the cactus fruit juice, without any harmful side effects.

What is claimed is:

1. An additive characterized in containing a fruit juice of a prickly pear cactus.

2. A food product characterized in containing the additive according to claim 1.

3. A beverage characterized in containing the additive according to claim 1.

4. A seasoning characterized in containing the additive according to claim 1.

5. A cosmetic product characterized in containing the additive according to claim 1.

6. An additive characterized in containing a powdered material created by processing a fruit juice of a prickly pear cactus into powder form.

7. A food product characterized in containing the additive according to claim 6.

8. A beverage characterized in containing the additive according to claim 6.

9. A seasoning characterized in containing the additive according to claim 6.

10. A cosmetic product characterized in containing the additive according to claim 6.
